(19) United States
(12) Patent Application Publication
(10) Pub. No.: US 2008/0138630 A1
(43) Pub. Date: Jun. 12, 2008

(54) Assembly including polytetrafluoroethylene porous body

(75) Inventor: Yoshikazu Yasukawa, Shizuoka (JP)

Correspondence Address: MORGAN LEWIS & BOCKIUS LLP, 1111 PENNSYLVANIA AVENUE NW, WASHINGTON, DC, 20004, US

(73) Assignees: NGK Spark Plug Co., Ltd.; Kurabe Industrial Co., Ltd.

(21) Appl. No.: 11/635,792

(22) Filed: Dec. 8, 2006

(51) Int. Cl. B32B 27/00

(52) U.S. Cl. 428/422

(57) ABSTRACT

An assembly including a fluorine rubber molding, and a polytetrafluoroethylene porous body which has pores and is held on the fluorine rubber molding, wherein the polytetrafluoroethylene porous body is obtained by molding a polytetrafluoroethylene paste containing 100 parts by weight of a polytetrafluoroethylene powder and 7 parts by weight or more of a pore forming agent, the pore forming agent being held on the polytetrafluoroethylene powder by viscosity of the pore forming agent, and removing the pore forming agent.

### BACKGROUND OF THE INVENTION

1. Field of the Invention

The present invention relates to an assembly including a polytetrafluoroethylene (hereinafter referred to as “PTFE”) porous body. In particular, it relates to an assembly including PTFE porous body having fine texture.

2. Description of the Related Art

PTFE porous body has excellent heat resistance and chemical resistance, and further has excellent electric properties such as dielectric constant and energy loss angle, and therefore is used in various applications such as a wire covering material, a dielectric of a coaxial cable, a filter, a gasket, a heat-insulting material, a separation membrane, an artificial blood vessel, a catheter and an incubator. As a production method of such a PTFE porous body, a production method is generally widely known that a mixture of a PTFE powder and a binder are finely ground and then molded by the conventional method,. and the resulting molding is baked. As other production method, a production method is generally widely known that a mixture of a PTFE powder and a pore forming agent is molded into a predetermined shape, and the pore forming agent is removed, thereby providing pores in the molding.

For example, JP-A-61-66730 discloses a method of producing a PTFE porous body by baking unbaked PTFE at a temperature higher than the melting point of the PTFE, grinding the baked PTFE to prepare a baked PTFE powder, molding the powder into a predetermined shape under a pressure of from 1 g/cm² to 800 kg/cm², and again baking the resulting molding at a temperature higher than the melting point of the PTFE.

For example, JP-A-5-93086 discloses a production method of a PTFE porous body comprising a step of mixing PTFE powder and binder having a melting point lower than the melting point of the PTFE and having a decomposition temperature higher than the baking temperature of the PTFE, a step of gelating the mixture and then finely grinding, a step of subjecting the finely ground powder to ram extrusion molding to form a preform, and baking the preform under an unrestricted condition.

For example, JP-B-42-13560 discloses a method of producing a porous body by molding PTFE containing a liquid lubricant acting as a pore forming agent, and heating under a stretched state. Further, the prior art discloses a method of producing a porous body by mixing PTFE and a liquid lubricant acting as a pore forming agent, molding the resulting mixture, and removing the liquid lubricant. Naphtha, white oil, toluol, xylol and the like are exemplified as the liquid lubricant.

Further, JP-B-57-30059 discloses a method of producing a porous body by molding a mixture of a PTFE powder, and added thereto a foaming agent and a liquid lubricant both acting as a pore forming agent, into a predetermined shape, heating the mixture to foam the same, thereby forming numberless fine pores, and then stretching. Azo type foaming agents, hydrazide type foaming agents, semicarbazide type foaming agents, nitroso type foaming agents, ammonium carbonate, sodium bicarbonate, ammonium nitrite and the like are exemplified as the foaming agent. Liquid paraffin, naphtha, white oil, toluene, xylene and the like are exemplified as the liquid lubricant.

Further, JP-A-60-93709 discloses a production method comprising mixing a PTFE powder, and a pore forming agent, an inflating agent and a lubricant each acting as a pore forming agent, cold extruding the resulting mixture, and successively conducting evaporation of the lubricant, sublimation or decomposition of the pore forming agent and the inflating agent, and sintering of PTFE. A mixture of aliphatic hydrocarbons is exemplified as the lubricant. Compounds such as benzene, toluene, naphthalene, benzaldehyde and aniline, and monohalogenated and polyhalogenated derivatives of those compounds are exemplified as the pore forming agent. Azodicarbonamide, modified azodicarbonamide, 5-phenyltetrazole and its derivative, and aromatic derivatives of hydrazine are exemplified as the inflating agent.

Further, JP-A-11-124458 and JP-A-2001-67944 disclose that PTFE containing a pore forming agent is heated and baked, and during baking, PTFE is made porous by the action of the pore forming agent. Ammonium bicarbonate, ammonium carbonate and ammonium nitrile are exemplified as the pore forming agent.

Further, JP-T-2004-500261 (the term “JP-T” as used herein means a published Japanese translation of a PCT patent application) discloses a method of producing a porous body by extrusion molding PTFE containing a foaming agent as a pore forming agent, and removing the foaming agent. Azo compounds, sodium carbonate, ammonium carbonate, hydrazine, tetrazole, benzoxazine, semicarbazide and the like are exemplified as the foaming agent.

3. Problems to be Solved by the Invention

However, in the production method of again molding the finely ground PTFE powder as disclosed in JP-A-61-66730 and JP-A-5-93086, a diameter of pores becomes coarse. As a result, not only a molding having fine texture cannot be obtained, but it is very difficult to obtain a molding having high porosity, and to control the porosity. Further, batchwise molding with a mold or continuous molding by ram extrusion is possible, but continuous molding by paste extrusion is very difficult.

Further, a pore forming agent, a liquid lubricant acting as a pore forming agent, a foaming agent, a pore forming agent, an inflating agent and a lubricant as disclosed in JP-B-42-13560, JP-B-57-30059, JP-A-60-93709, JP-A-11-124458, JP-A-2001-67944 and JP-T-2004-500261 are a liquid having low viscosity or a powder. Further, the conventional pore forming agent generally and widely used is naphtha, and this is also a liquid having low viscosity. Where those pore forming agents are used, the following problems occur.

Where the pore forming agent is composed of only a liquid having low viscosity, only a predetermined amount of a liquid having low viscosity is held on a PTFE powder, and the excessive portion oozes out. Therefore, it is difficult to produce a porous body having a porosity exceeding 25%. Additionally, where such a porous body is completely baked, there is the problem that pores are crushed, thereby decreasing the porosity.

Where the pore forming agent is a powder, portions from which powder particles have been removed constitute pores, so that the pores become coarse, and further, the powder particles are liable to be an undissolved lump shape. As a result, the pores become further coarse, and a porous body having fine texture cannot be produced. Where such coarse pores are present, mechanical strength deteriorates such that when external force such as bending is applied to the porous body, stress concentrates at the pore portions, resulting in generation of crack or cutting. Further, where powdery pore forming agent is mixed in a large amount, when conducting extrusion molding, pipe wall resistance increases, resulting in increase of inner pressure of an extruder. As a result, there is the problem that extrusion moldability deteriorates.

Where the pore forming agent is a mixture of a liquid having low viscosity and a powder, the same problems as in the case that the pore forming agent is a powder and the case that the pore forming agent is a liquid having low viscosity involve. That is, portions from which powder particles have been removed constitute pores, so that the pores become coarse, and further, because viscosity of the liquid is low, the powder particles cannot be held in a dispersed state, and the powder particles are liable to be an undissolved lump shape. As a result, the pores become further coarse, and a porous body having fine texture cannot be produced. Where a liquid pore forming agent having low viscosity is mixed in a large amount, its excessive portion oozes out. Further, where powdery pore forming agent is mixed in a large amount, when conducting extrusion molding, pipe wall resistance increases, resulting in increase of inner pressure of an extruder. As a result, extrusion moldability deteriorates.

In the case of conducting stretching as in JP-B-42-13560 and JP-B-57-30059, a special apparatus is required, and this increases production steps. As a result, productivity decreases. In the case of stretching, it is difficult to control the porosity.

The present invention has been made to solve those prior art problems, and its object is to particularly provide an assembly including PTFE porous body having fine texture.

### SUMMARY OF THE INVENTION

To achieve the above object, the assembly according to the present invention comprises a fluorine rubber molding and a polytetrafluoroethylene porous body having pores held thereon, the polytetrafluoroethylene porous body being obtained by molding a polytetrafluoroethylene paste comprising 100 parts by weight of a polytetrafluoroethylene powder and 7 parts by weight or more of a pore forming agent, the pore forming agent being held on the polytetrafluoroethylene powder by viscosity of the pore forming agent, into a predetermined shape, and removing the pore forming agent.

In the assembly of the invention, preferably, the PTFE porous body and the fluorine rubber molding are adhered with an adhesive.

In the assembly of the invention, preferably, the PTFE porous body is provided on the position to be held under the state of the fluorine rubber molding being unvulcanized or semi-vulcanized, and the fluorine rubber molding and the PTFE porous body are heated to vulcanize the fluorine rubber molding, thereby integrating the fluorine rubber molding and the PTFE porous body.

In the assembly of the invention, preferably, the PTFE porous body has grooves or projections formed thereon, the fluorine rubber molding has projections or grooves corresponding to the grooves or projections of the PTFE porous body, respectively, formed thereon, and the PTFE porous body is held on the fluorine rubber molding such that the grooves and projections formed respectively are fitted.

In the assembly of the invention, preferably, the PTFE porous body has a ring member provided on the circumference thereof.

In the assembly of the invention, preferably, the polytetrafluoroethylene porous body is plated with a metal.

According to the assembly obtained in the present invention, an assembly including a PTFE porous body having fine texture can be formed, and further, the porosity can easily be controlled by freely setting the amount of the pore forming agent mixed with PTFE. This enables the porosity to easily control and also enables a porous body having high porosity to produce. In addition, because pipe wall resistance does not increase, extrusion moldability does not deteriorate when conducting extrusion molding.

The following advantages can be obtained by that the PTFE porous body has fine texture. Size of pores is fine and uniform, and coarse pores are not present. Therefore, even when external force such as bending is applied to the PTFE porous body, stress is dispersed, and crack or cutting is difficult to occur. As a result, the PTFE porous body has excellent mechanical strength. Further, where the PTFE porous body is used in the application of a heat-insulating material, because the pores are fine, heat transfer by radiation which is one element of heat conduction can be reduced. Where the PTFE porous body is used in the application of a sealing material such as a gasket, because surface smoothness is improved, sealing properties can be improved. Where the PTFE porous body is used in the application of an insulator such as wire covering, dielectric breakdown strength can be improved. Where the PTFE porous body is used in the application of a dielectric, because a dielectric constant differs between the pore portion and the portion at which PTFE is present, if the pores are coarse and ununiform, unevenness causes in delay time of signal at partial part. However, where the pores are fine and uniform, such unevenness can be prevented.

Further, the following advantages can be obtained by making the porosity of the PTFE porous body be high. Because specific gravity of the porous body as a whole can be decreased, this can answer to the requirement of lightweight. Where the PTFE porous body is used in the application of a heat-insulating material, the content of air having low heat conductivity increases, and as a result, heat-insulating effect can be improved. Where the PTFE porous material is used in the application of a filter, conduction passages increase, and as a result, the life can be prolonged until clogging. Where the PTFE porous body is used in the application of a dielectric, the effective dielectric constant (εₑ) is driven from the dielectric constant (ε_{A}) of PTFE and the porosity (V) by the following equation.

εₑ=ε_{A}^{1-V}

Therefore, the effective dielectric constant can be decreased. Further, the delay time (τ) of signal can be driven from the effective dielectric constant (εₑ) of the porous body by the following equation.

τ=3.33561√εₑ(ns/m)

Therefore, the delay time of signal can be decreased by increasing the porosity.

### BRIEF DESCRIPTION OF THE DRAWINGS

FIG. 1 is a view showing Example 1, and showing the pore state of the PTFE porous body.

FIG. 2 is a view showing Example 2, and showing the pore state of the PTFE porous body.

FIG. 3 is a view showing Example 3, and showing the pore state of the PTFE porous body.

FIG. 4 is a view showing Example 4, and showing the pore state of the PTFE porous body.

FIG. 5 is a view showing Example 5, and showing the pore state of the PTFE porous body.

FIG. 6 is a view showing Example 6, and showing the pore state of the PTFE porous body.

FIG. 7 is a view showing Example 7, and showing the pore state of the PTFE porous body.

FIG. 8 is a view showing Example 8, and showing the pore state of the PTFE porous body.

FIG. 9 is a view showing Example 9, and showing the pore state of the PTFE porous body.

FIG. 10 is a view showing Example 10, and showing the pore state of the PTFE porous body.

FIG. 11 is a view showing Example 11, and showing the pore state of the PTFE porous body.

FIG. 12 is a view showing Example 12, and showing the pore state of the PTFE porous body.

FIG. 13 is a view showing Example 13, and showing the pore state of the PTFE porous body.

FIG. 14 is a view showing Example 14, and showing the pore state of the PTFE porous body.

FIG. 15 is a view showing Example 15, and showing the pore state of the PTFE porous body.

FIG. 16 is a view showing Example 16, and showing the pore state of the PTFE porous body.

FIG. 17 is a view showing Example 17, and showing the pore state of the PTFE porous body.

FIG. 18 is a view showing Example 18, and showing the pore state of the PTFE porous body.

FIG. 19 is a view showing Example 19, and showing the pore state of the PTFE porous body.

FIG. 20 is a view showing Comparative Example 1, and showing the pore state of the PTFE porous body.

FIG. 21 is a view showing Comparative Example 2, and showing the pore state of the PTFE porous body.

FIG. 22 is a view showing Comparative Example 3, and showing the pore state of the PTFE porous body.

FIG. 23 is a view showing Comparative Example 6, and showing the pore state of the PTFE porous body.

FIG. 24 is a view showing a crystal diffusion curve of Example 1 by differential scanning calorimetry (DSC).

FIGS. 25A and 25B are views showing the assembly comprising the fluorine rubber molding and the PTFE porous body held thereon, wherein FIG. 25A is a perspective view, and FIG. 25B is a sectional view taken along b-b′ in FIG. 25A.

FIGS. 26A and 26B are views showing the assembly comprising the fluorine rubber molding and the PTFE porous body held thereon, wherein FIG. 26A is a perspective view, and FIG. 26B is a sectional view taken along b-b′ in FIG. 26A.

FIGS. 27A and 27B are views showing the assembly comprising the fluorine rubber molding and the PTFE porous body held thereon, wherein FIG. 27A is a perspective view, and FIG. 27B is a sectional view taken along b-b′ in FIG. 27A.

### DESCRIPTION OF REFERENCE NUMERALS

Reference numerals used to identify various structural features in the drawings include the following.
1a Coarse pores

### DETAILED DESCRIPTION OF THE INVENTION

One embodiment of the pore forming agent to be mixed with the PTFE powder for the PTFE paste used in the assembly of the present invention includes a pore forming agent having viscosity. There are various cases as the case that the pore forming agent develops viscosity. For example, the case that a pore forming agent component partially melts to develop viscosity, the case that the pore forming agent itself is a composition-deformable viscous body, the case that the pore forming agent is a colloid, that is, a solid is dispersed in a liquid to develop viscosity, and the like are considered.

Examples of the pore forming agent having viscosity include materials containing a viscous body having a viscosity of 5 mPa·s or more in the environmental conditions when mixing the PTFE powder and the pore forming agent, and when molding a mixture of the PTFE powder and the pore forming agent into a predetermined shape. Viscosity of the viscous body can be measured using, for example, a rotating viscometer. In this case, the measurement conditions are set considering environmental conditions such as temperature and pressure when mixing and when molding.

So long as the pore forming agent contains such a viscous body, the pore forming agent easily changes its shape by applying pressure to fluidize, easily and evenly penetrates between particles of a powder such as PTFE powder, and is held there. Further, once the pore forming agent penetrates, the pore forming agent is held by its viscosity. Differing from the case that a fluid having low viscosity, such as naphtha and toluene, is directly used as the pore forming agent, once those pore forming agents are held between the particles of the powder, even where pressure is applied when molding into a predetermined shape, only the pore forming agent oozes out, and PTFE powder and the pore forming agent do not separate. Further, the powder particles are prevented from aggregating to form continuous powder, and the powder particles in such a fine state can be dispersed and held. Therefore, fine and uniform pores can be formed. When plural components are mixed and used as the pore forming agent, each component constituting the pore forming agent may be a powder or a liquid having low viscosity under the state that it is present in a form of a simple substance. It is sufficient only if a viscous body is contained under the state that the respective components constituting the pore forming agent are mixed.

When the pore forming agent is the above viscous body having a specific viscosity, pores due to the shape of the powder particles do not generate, and pores having further fine and uniform pores can be formed, which is further preferable.

When the pore forming agent has properties that it vaporizes in air by heating, it is easy to vaporize and remove the pore forming agent by heating, which is preferable. When the pore forming agent is removed by vaporizing, it is difficult to remain the residue of the pore forming agent in PTFE as compared with, for example, the case of removing the pore forming agent by thermal decomposition, and adverse influence to various electrical properties by the residue can be prevented. Where the pore forming agent having the properties that it vaporizes in air by heating is, for example, is a pore forming agent having a boiling point of 300° C. or lower, a special apparatus is not required, and the pore forming agent can easily be removed by, for example, a heating furnace generally used, which is preferable. Further, where the boiling point of the pore forming agent is 300° C. or lower, the pore forming agent is removed at a temperature lower than the baking temperature (370 to 400° C.) of PTFE, and as a result, an accident such that the pore forming agent component takes fire during baking can be prevented.

The pore forming agent satisfying the above-described requirements can use, for example, materials comprising terpenes as the main component. Examples of the terpenes include camphor, menthol, canphene and borneol. Of those, it is preferable that at least one selected from camphor and menthol is used as the main component.

In order that the pore forming agent contains a viscous body having a specific viscosity, an organic solvent may be used as one component of the pore forming agent. For example, menthol or camphor is a substance which is solid at ordinary temperature, but by mixing the same with an organic solvent, a viscous body having a specific viscosity can be obtained. Further, since viscosity of the pore forming agent can be adjusted by the mixing amount of the organic solvent, the mixing amount of the organic solvent can appropriately be set according to the mixing amount of the pore forming agent to the PTFE powder, a molding method when molding a mixture of the PTFE powder and the pore forming agent, and the like.

Examples of the organic solvent include hydrocarbons such as liquid paraffin, naphtha, white oil and kerosene; aromatic hydrocarbons such as toluene and xylene; alcohols; ketones; and esters. Of those, a petroleum solvent such as naphtha is preferably used from the standpoint of penetration into PTFE. However, where PTFE is baked, PTFE is generally baked at a temperature of from about 370 to 400° C. Therefore, if a solvent remains up to a high temperature when baking, there is the danger of the fire, and it is required that the solvent is completely evaporated before baking. For this reason, the boiling point of the organic solvent is preferably 300° C. or lower.

When both of camphor and menthol are contained, those are liquefied by mixing those. Therefore, it is possible to form a viscous body having a specific viscosity without an organic solvent. Of course, the organic solvent may be added to a mixture of camphor and menthol.

The pore forming agent is mixed in an amount of 7 parts by weight or more per 100 parts by weight of the PTFE powder. Where the mixing amount of the pore forming agent is less than 7 parts by weight, sufficient amount of pores cannot be obtained when removing the pore forming agent. In particular, when PTFE is baked, even though pores remain slightly, the pores are all crushed, and the pores do not remain at all.

As other embodiment of the pore forming agent to be mixed with the PTFE powder, terpenes such as camphor may directly be used as a powder. Terpenes such as camphor have flexibility that those are liable to undergo plastic deformation. Therefore, even when those are used as a pore forming agent in the form of a powder that does not contain a viscous body, those easily penetrate between particles of the PTFE powder and are held therein, and thereafter are held in the state of plastic deformation. For this reason, where it is a PTFE paste having such a pore forming agent mixed therewith, a PTFE porous body having fine and uniform pores formed therein can be obtained. Of course, terpenes may not be a powder, and may be in the state of a viscous body.

The pore forming agent and the PTFE powder are mixed by, for example, a tumbler to obtain a PTFE paste. In this case, porosity can easily be controlled by changing the mixing amount of the pore forming agent. Where plural components are mixed and used as the pore forming agent, if the respective components constituting the pore forming agent are previously mixed, the pore forming agent becomes homogeneous, and a PTFE porous body having further fine texture can be produced, which is preferable. A method may be employed that each component constituting the pore forming agent is separately added to the PTFE powder, and those are mixed all together by stirring or the like.

Other embodiment of the PTFE paste is that the PTFE powder and a powder or a viscous body of the pore forming agent are mixed so as to form integrated particles. Thus, where the PTFE powder and the pore forming agent are mixed so as to form integrated particles, even thought the pore forming agent is a powder, the pores do not become coarse as in JP-A-5-93086, JP-B-42-13560, JP-B-57-30059, JP-A-60-93709, JP-A-11-124458 and JP-A-2001-67944, and the PTFE porous body having fine texture can be obtained. Further, pipe wall resistance does not increase, and extrusion moldability becomes good. The term “integrated particle” used herein means that particles of the PTFE powder and particles of the pore forming agent are not substantially observed as separate particles, and are under the state of not easily separating into the respective particles.

Where the PTFE powder and the pore forming agent are mixed so as to form integrated particles as described above, the pore forming agent is not particularly limited. Examples of the pore forming agent include the terpenes described above, naphthalene, aniline, benzoic acid, ammonium bicarbonate, ammonium carbonate and ammonium nitrite. Of those, compounds that vaporize at a temperature lower than the baking temperature of the PTFE powder are difficult to leave the residue and are preferable. Further, the above-described terpenes, particularly camphor, is particularly preferable in that not only it is difficult to leave the residue, but it is liable to be integrated with the PTFE powder. Of course, the above-described organic solvent may be mixed with those pore forming agents.

A method of mixing the PTFE powder and the pore forming agent so as to form integrated particles includes a method that after or during mixing the PTFE powder and the pore forming agent, shear stress is applied between the PTFE powder and the pore forming agent to integrate those. Specifically, there are, for example, a method of kneading the PTFE powder and the pore forming agent with rolls or the like to integrate those, and crushing the integrated particles to form a fine powder, and a method of applying shear strength between the PTFE powder and the pore forming agent with a high speed rotating blade such as a mixer to integrate those. Of those, the latter is preferable in that integrating and fine powder formation by crushing can be conducted at the same step. Where the above-described organic solvent is added, the organic solvent may be added before integrating or may be added after integrating. Further, a part of the organic solvent may be added before integrating and the remainder may be added after integrating.

The PTFE paste is molded into a predetermined shape, and the pore forming agent is removed to form pores in PTFE, thereby the PTFE porous body is prepared. In molding the PTFE paste, the molding can be conducted by various molding methods generally known. For example, the PTFE paste may be molded with, for example, a mold to form a bulk-like material, or may be molded by roll molding to form a film-like material. Further, because pipe wall resistance does not increase, extrusion molding can be conducted. Therefore, a conductor may be covered with the PTFE paste by extrusion molding to form an electric wire. As a method of removing the pore forming agent, it is preferable to vaporize the pore forming agent by heating from the standpoint of ease of facilities. However, it is considered to vaporize the pore forming agent under reduced pressure.

When the PTFE paste is molded, or after the PTFE paste was molded, a skin layer can be formed on the PTFE porous body by applying shear stress to the surface thereof. The specific embodiment of forming the skin layer is, for example, that the skin layer is formed by the extrusion molding described above.

The PTFE porous body included in the assembly of the present invention may be used as an unbaked PTFE porous body by removing the pore forming agent by, for example, heat treatment at about 200° C. without the subsequent baking. Further, after removing the pore forming agent, the PTFE porous body is baked at 370° C. or higher, and may be used as a completely baked PTFE. Further, a PTFE porous body containing a mixture of the unbaked PTFE porous body and the completely baked PTFE porous body may be prepared by controlling the baking temperature. Stretching processing may further be added to those PTFE porous bodies.

The PTFE porous body thus obtained can be a porous body having a porosity of 5% or more, an average pore diameter of 300 μm or less and a hardness of less than A95 even though it is a completely baked and non-stretched PTFE porous body. Such a PTFE porous body can suitably be used as a dielectric of a coaxial cable having excellent dielectric constant, or a bulk filter. In particular, when the average pore diameter is 100 μm or less, high filter function is developed as a filter for the purpose of separating a gas (such as air and water vapor) and a liquid (such as water), or a gas (such as air and water vapor) and a solid (such as powder), and this is preferable. Further, by increasing the mixing amount of the pore forming agent, it is possible to obtain the PTFE porous body having a porosity of, for example, 80% or more.

The PTFE porous body thus obtained can control a pore state. For example, the pore state can be formed such that when the porosity is from 5 to less than 40%, the pores mainly comprise closed pores; when the porosity is 40 to less than 50%, the pores mainly comprise closed pores and continuous pores; and when the porosity is 50% or more, the pores mainly comprise closed pores.

The PTFE porous body thus obtained is held on the fluorine rubber molding to form an assembly. The assembly comprising the fluorine rubber molding and the PTFE porous body held thereon can use under high temperature environment. Therefore, for example, it is possible to suitably use in grommet equipped with a filter used in an oxygen sensor.

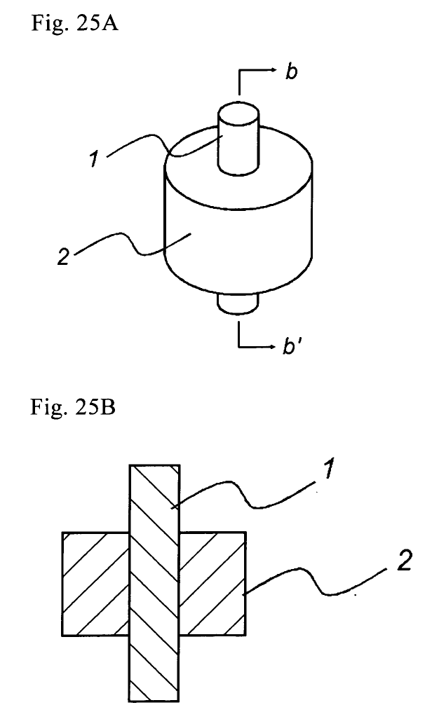

Specific example of the assembly includes an assembly shown in FIGS. 25A and 25B. FIGS. 25A and 25B show an embodiment that a PTFE porous body I is held in a through-hole of a fluorine rubber molding 2 formed into a shape having the through-hole provided therein. In this case, an adhesive may be applied to the fluorine rubber molding 2 and/or the PTFE porous body 1 to adhere the fluorine rubber molding 2 and the PTFE porous body 1. Examples of the adhesive include a fluorine rubber adhesive, a silane solution, a titanate solution and an aluminate solution. The fluorine rubber molding 2 and the PTFE porous body 1 may be integrated by providing the PTFE porous body 1 in the through-hole of the fluorine rubber molding 2 in the state that the fluorine rubber molding 2 is unvulcanized or semi-vulcanized, and then heating the fluorine rubber molding 2 and the PTFE porous body 1 to thereby vulcanize the fluorine rubber molding 2. Further, the PTFE porous body 1 may be held on the fluorine rubber molding 2 by arranging the PTFE porous body 1 at a predetermined position, and molding a fluorine rubber on the circumference thereof by extrusion molding or the like.

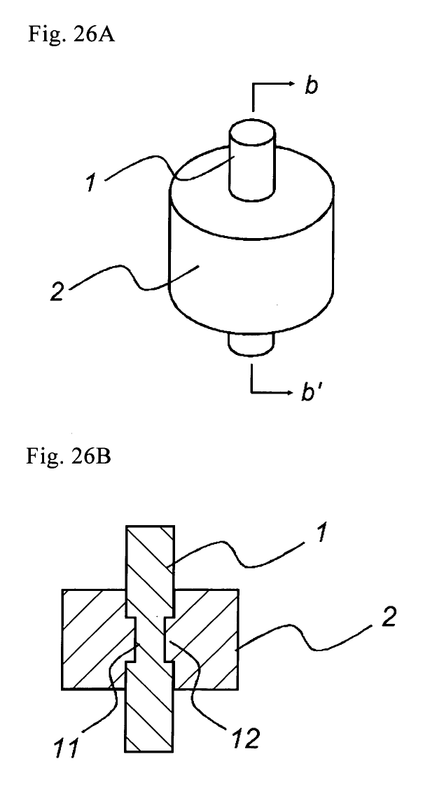

Other specific example of the assembly includes an assembly as shown in FIGS. 26A and 26B. FIGS. 26A and 26B show an embodiment that the PTFE porous body 1 is held in the through-hole of the fluorine rubber molding 1 molded into a shape having the through-hole provided therein. A groove 11 is formed on the side of the PTFE porous body 1, a projection 12 is formed on the through-hole of the fluorine rubber molding 2, and the groove 11 and the projection 12 are fitted. By this structure, the PTFE porous body 1 does not drop out of the fluorine rubber molding 2, and is surely held thereon. Of course, a projection may be formed on the side of the PTFE porous body 1, and a groove may be formed on the through-hole of the fluorine rubber molding 2. Further, the shape of groove and projection is not limited, and a shape that is liable to fit and is difficult to drop out may appropriately be selected.

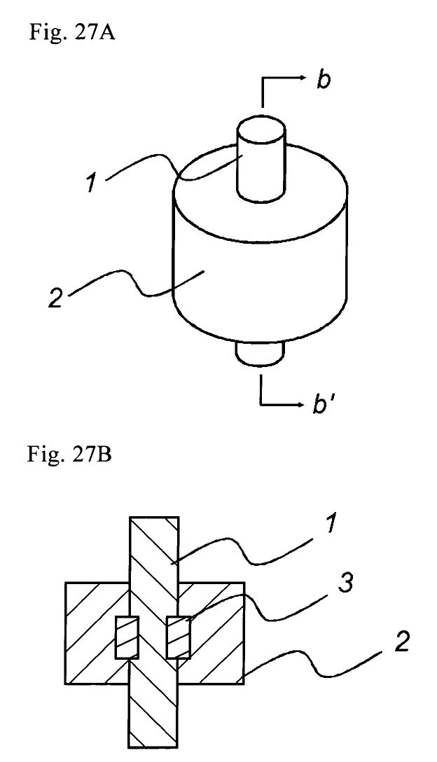

Other specific example of the assembly includes an assembly as shown in FIGS. 27A and 27B. FIGS. 27A and 27B show an embodiment that the PTFE porous body 1 is held in the through-hole of the fluorine rubber molding 2 molded into a shape having the through-hole provided therein, and a ring member 3 is provided and fixed on the circumference of the PTFE porous body 1. Thus, because the ring member 3 is provided and fixed on the circumference of the PTFE porous body 1, the PTFE porous body 1 does not drop out of the fluorine rubber molding 2, and is surely held thereon. There is no limitation on a shape and the like of the ring member 3, and for example, a cylindrical ring member or a coil-like ring member may be used, and a plurality of the ring member 3 may be used. When the ring member 3 is made of a metal, the ring member 3 can be provided and fixed so as not to generate a space between the same and the PTFE porous body I by fitting processing. Further, because the fluorine rubber has the property that is liable to adhere to a metal material, a space between the fluorine rubber molding 2 and the ring member 3 can easily be eliminated.

For the purpose of adhering the fluorine rubber molding 2 and the PTFE porous body 1 without a space, a surface treatment may be applied to the PTFE porous body 1. Examples of the surface treatment include a discharge treatment by corona discharge or plasma discharge, a radiation treatment, a UV treatment, a laser treatment, a flame treatment and formation of a metal plating layer. Of those, formation of a metal plating layer is preferable from the reason that the fluorine rubber has the property that is liable to adhere to a metal material as described above. Examples of the formation method of a metal plating layer include plating by a metal colloid solution, plating by vacuum deposition, plating by molten metal, and electrolytic plating. The formation method is appropriately selected from those methods, and those methods may appropriately be combined.

The above description shows the embodiment that the PTFE porous body used in the assembly of the present invention is utilized as a filter. However, the embodiment may be employed that a conductor is covered with the PTFE porous body to prepare an insulating wire (a lead wire), and the insulating wire is held on the fluorine rubber molding to prepare a grommet equipped with a lead wire.

### EXAMPLES

Examples of the PTFE porous body included in the assembly of the present invention, and Comparative Examples are described below.

### Examples 1 to 12

Naphtha, camphor and menthol were mixed in the amounts (parts by weight) as shown in Table 1, and the resulting mixture was mashed up on a mortar to obtain a pore forming agent containing a viscous body. The pore forming agent and 100 parts by weight of a PTFE powder was mixed to obtain a PTFE paste. The PTFE paste was placed in a cylindrical mold having an inner diameter of 4 mm, compression molded therein under a pressure of about 40 kgf/cm² for 30 seconds. The resulting molding was taken out of the mold, and heat treated at 250° C. for 10 minutes to remove the pore forming agent by vaporization. The molding thus treated was subjected to a baking treatment at 400° C. for about 10 minutes to prepare a sample piece. Example 13 Naphtha, camphor (powder) and a PTFE powder were mixed in the amounts (parts by weight) as shown in Table 2 to obtain a PTFE paste. The PTFE paste was placed in a cylindrical mold having an inner diameter of 7 mm, and preliminarily compression molded therein under a pressure of about 40 kgf/cm² for 30 seconds. A cylinder having an outer diameter of 7 mm and an inner diameter of 4 mm was pushed into the mold to obtain a columnar molding having an outer diameter of about 4 mm by extrusion molding. The molding thus obtained was heat treated at 250° C. for 10 minutes to remove the pore forming agent by vaporization, and then subjected to a baking treatment at 400° C. for about 10 minutes to prepare a sample piece.

### Examples 14 to 19

Naphtha, camphor (powder) and a PTFE powder were mixed in the amounts (parts by weight) as shown in Table 2, and the resulting mixture was subjected to an integrating treatment with a mixer having a rotating blade for about 3 minutes to obtain a PTFE paste. The PTFE paste was placed in a cylindrical mold having an inner diameter of 7 mm, and preliminarily compression molded therein under a pressure of about 40 kgf/cm² for 30 seconds. A cylinder having an outer diameter of 7 mm and an inner diameter of 4 mm was pushed into the mold to obtain a columnar molding having an outer diameter of about 4 mm by extrusion molding. The molding thus obtained was heat treated at 250° C. for 10 minutes to remove the pore forming agent by vaporization, and then subjected to a baking treatment at 400° C. for about 10 minutes to prepare a sample piece.

### Comparative Examples 1 to 3

Pulverized ammonium bicarbonate mashed in a mortar, naphtha and a PTFE powder were mixed in the amounts (parts by weight) as shown in Table 3. Using this mixture, a sample piece was prepared in the same method as in Example 1.

### Comparative Examples 4 and 5

Naphtha and a PTFE powder were mixed in the amounts (parts by weight) as shown in Table 3. Using this mixture, a sample piece was prepared in the same method as in Example 1.

### Comparative Example 6

A PTFE powder was baked by conducting a heat treatment at about 360° C., and was ground with a grinding machine to prepare a powder having an average particle diameter of about 100 μm. The powder was subjected to a mold press molding at 370° C. to prepare a columnar sample piece having a diameter of 2 mm and a length of 15.6 mm.

Porosity and pore state of the sample pieces according to Examples 1 to 12 of the present invention are shown in Table 1, porosity and pore state of the sample pieces according to Examples 13 to 19 of the present invention are shown in Table 2, and porosity and pore state of the sample pieces according to Comparative Examples 1 to 6 are shown in Table 3. The porosity was calculated by the following equation except for the case of not mixing a pore forming agent.

Porosity(%)=100−(specific gravity of sample piece/specific gravity of reference sample piece)×100

wherein the reference sample piece is the sample piece prepared in the same method as in Example 1.

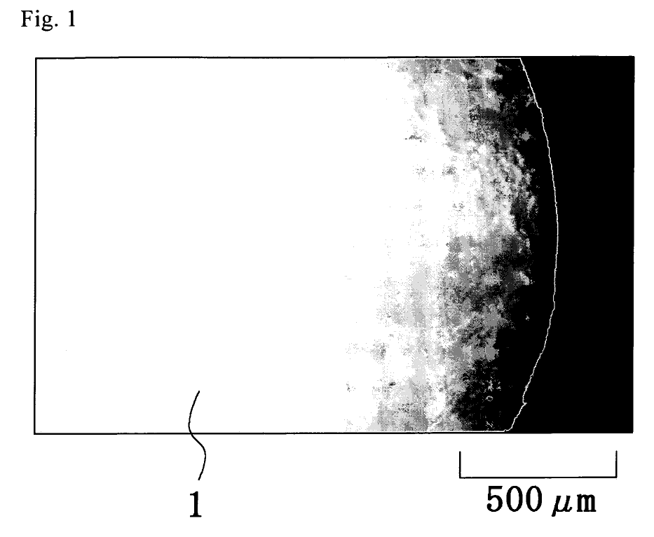

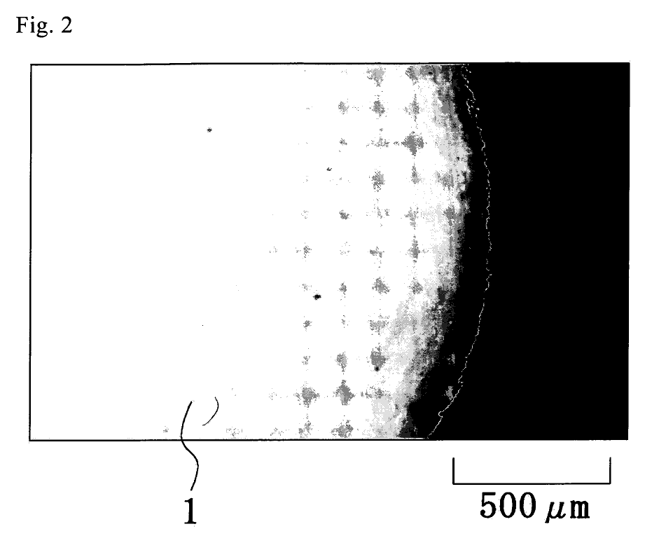

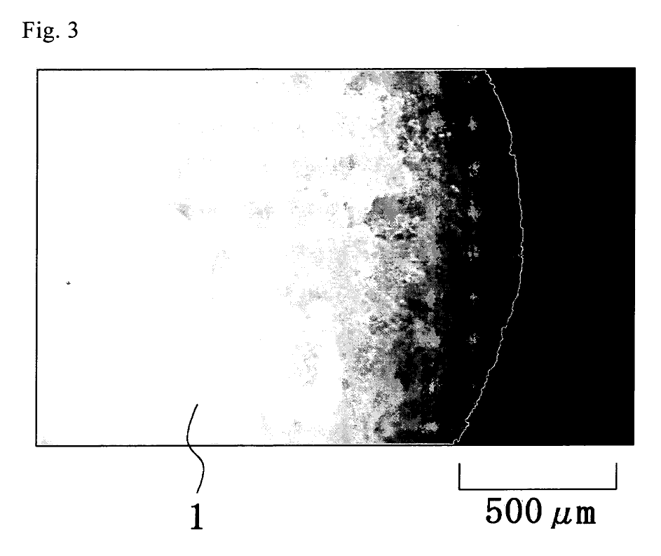

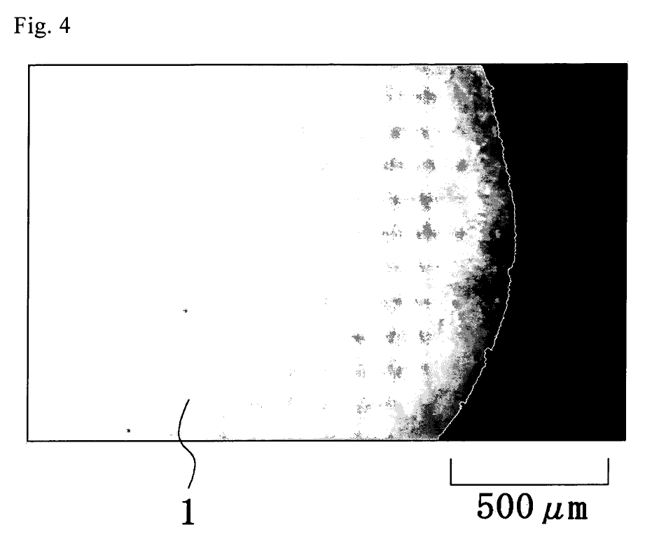

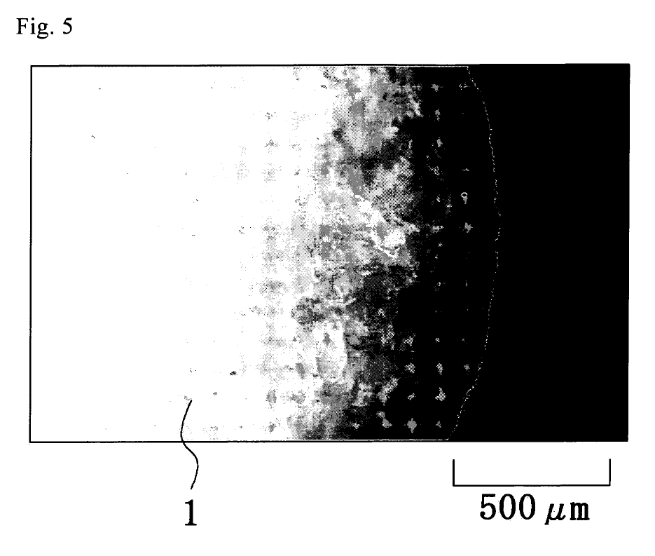

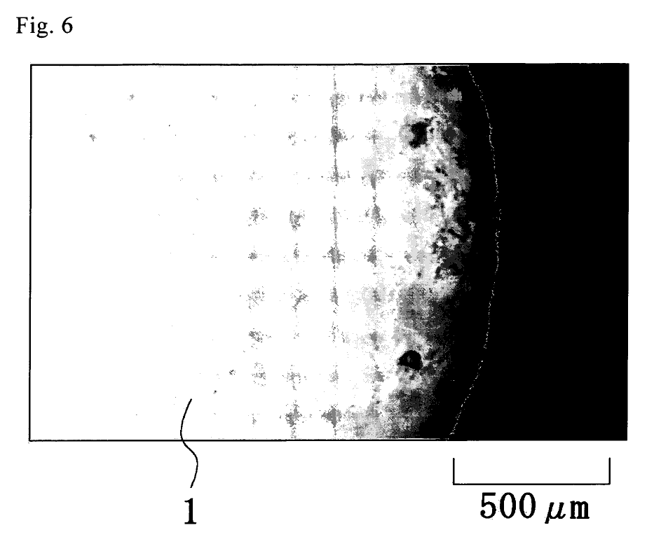

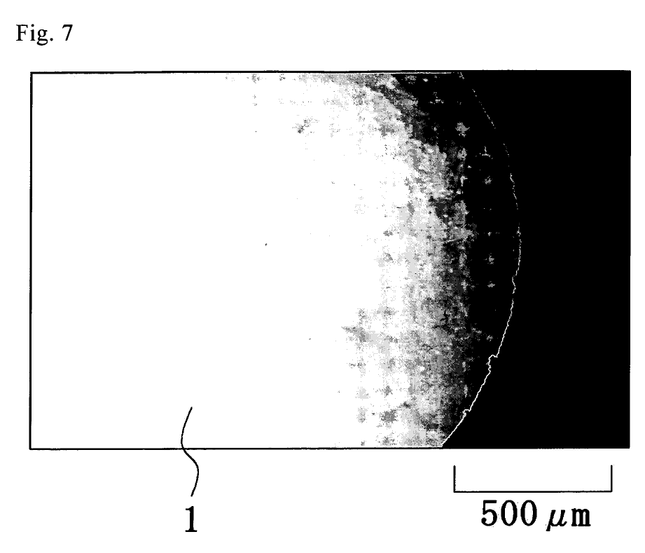

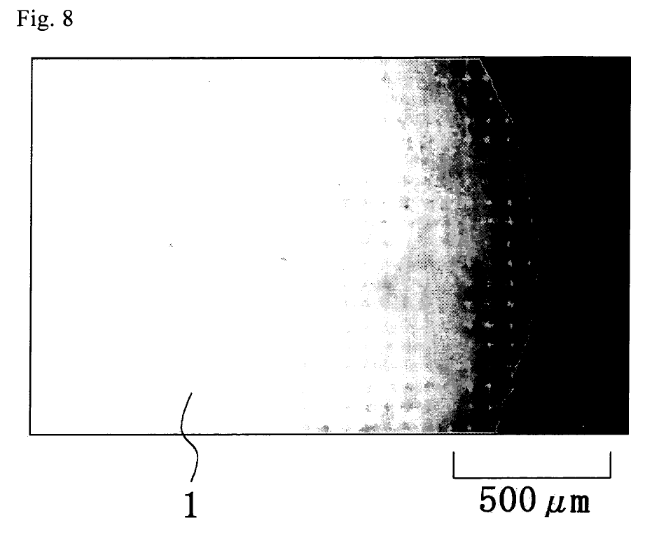

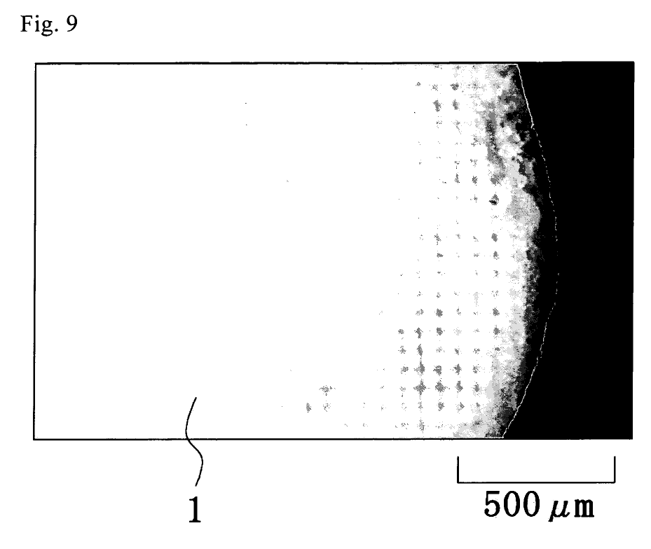

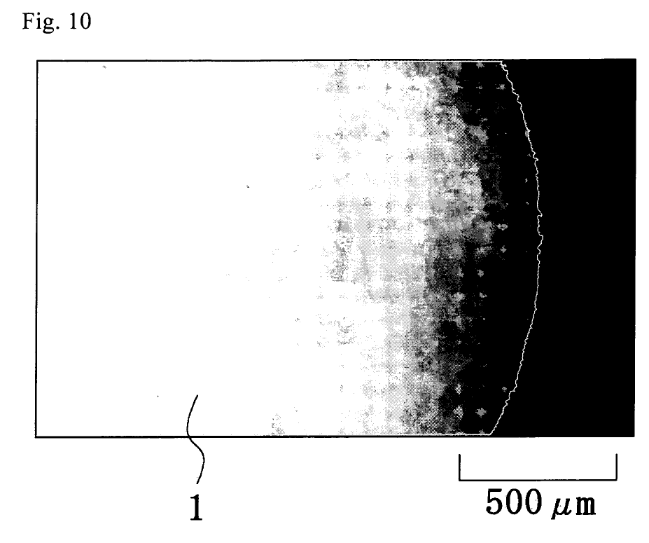

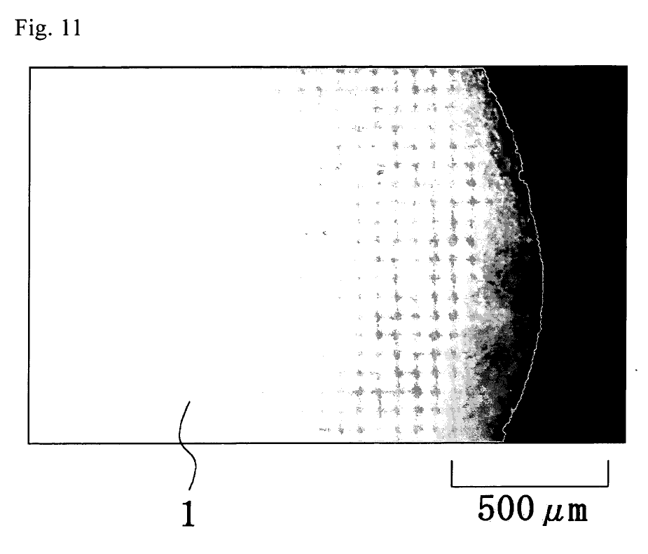

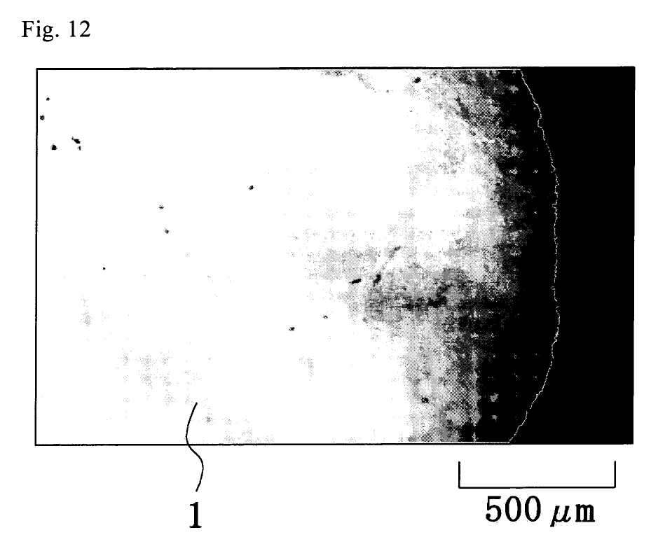

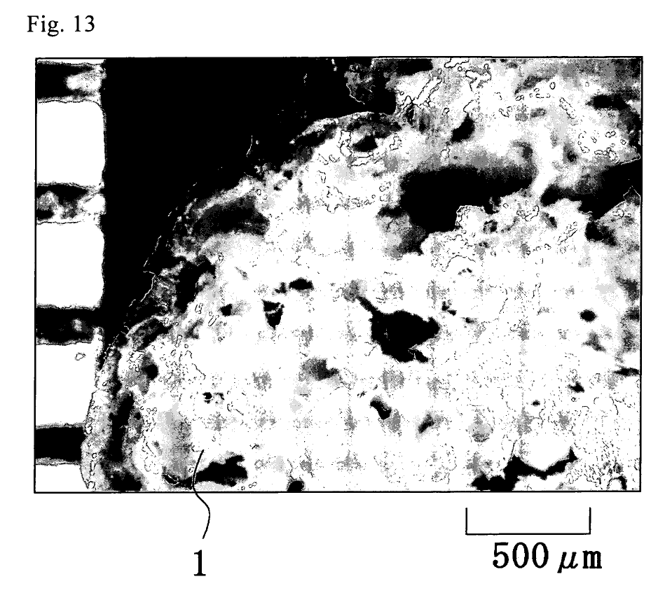

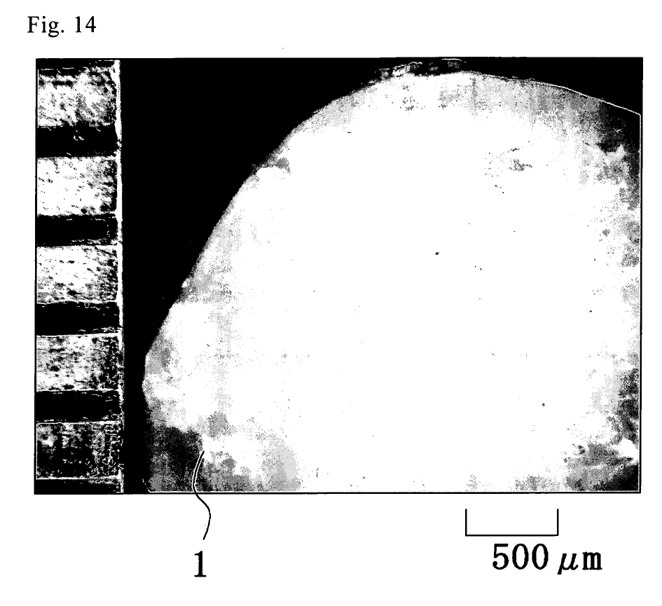

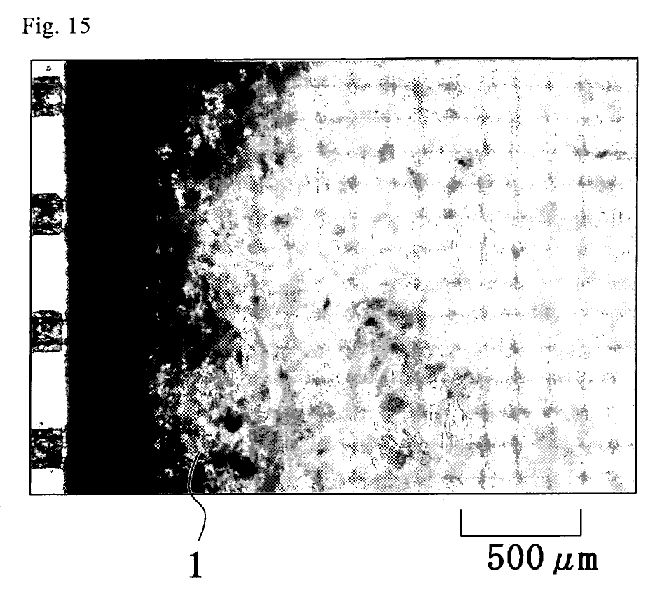

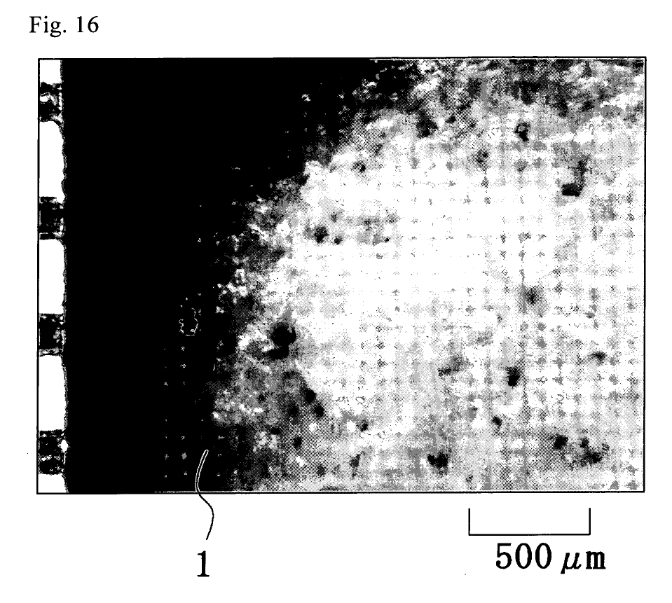

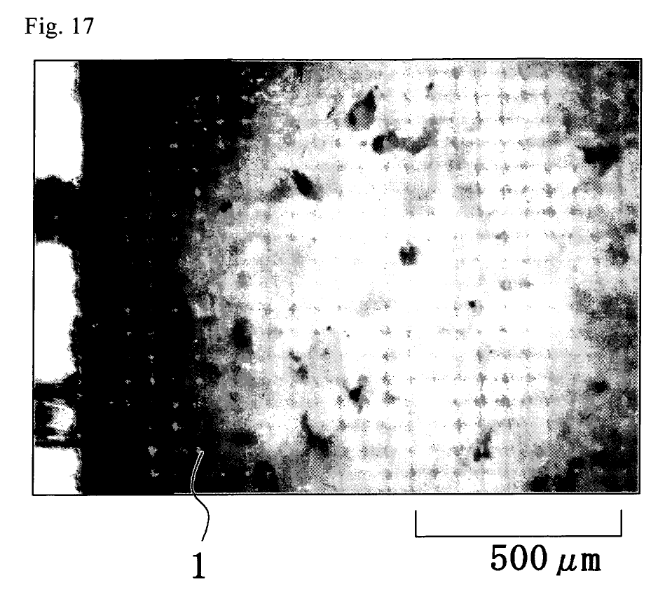

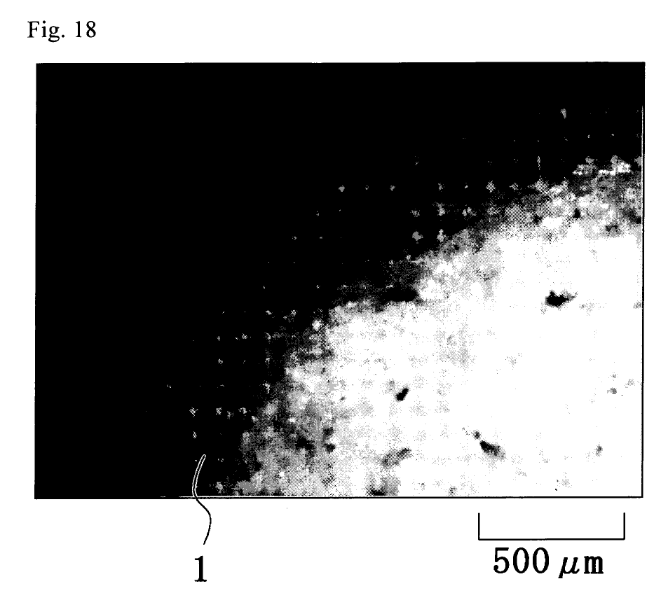

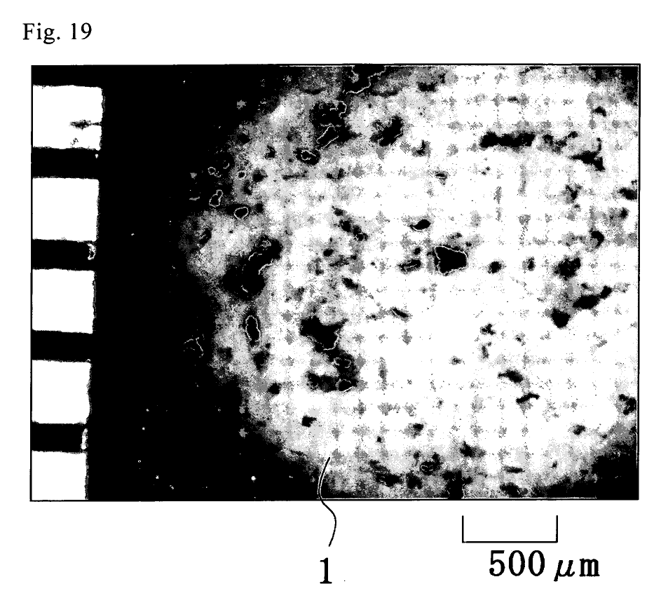

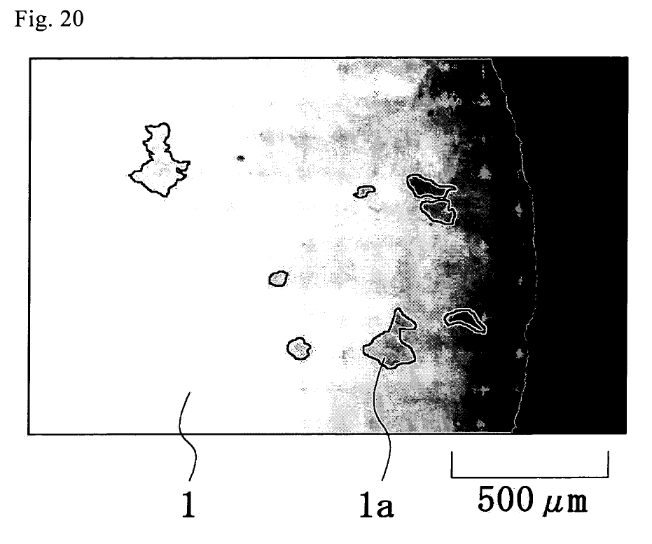

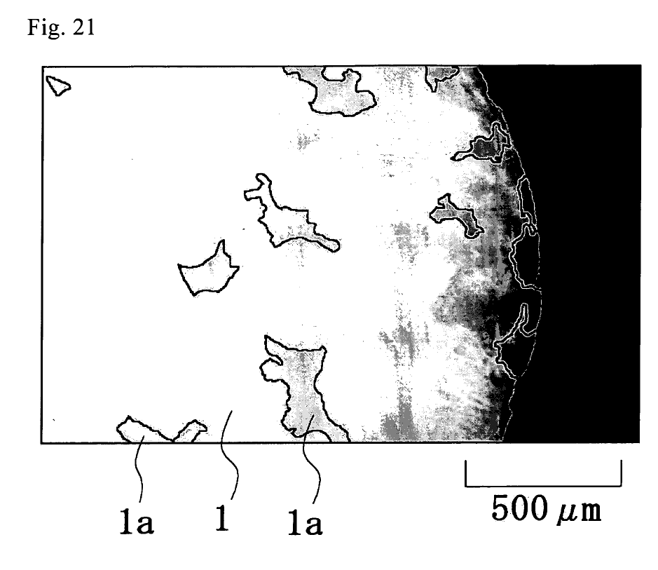

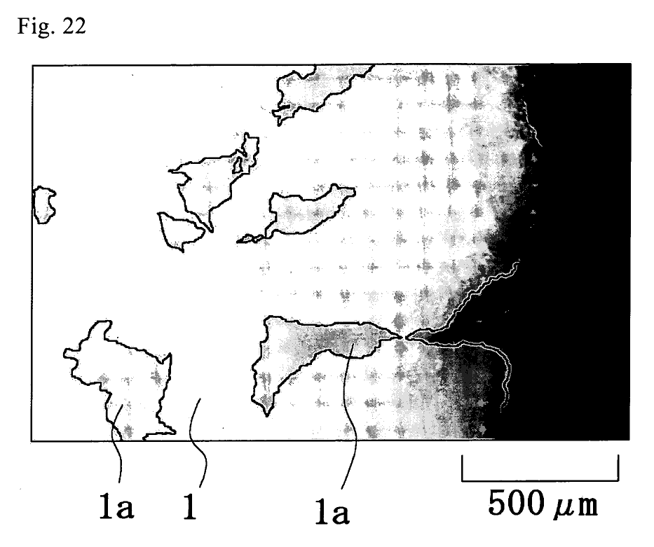

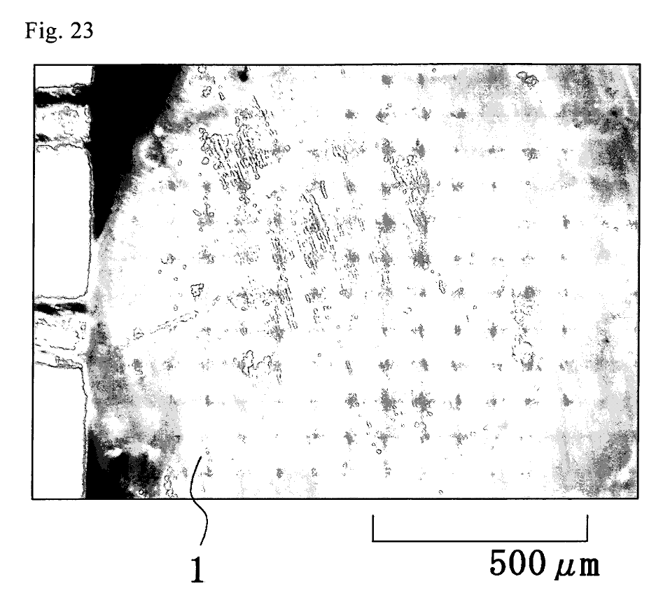

The pore state was confirmed by observing a cut face of a sample piece with a knife with a microscope. FIGS. 1 to 19 show photographs showing the pore state of the sample pieces according to Examples 1 to 19, respectively, FIGS. 20 to 22 show photographs showing the pore state of the sample pieces according to Comparative Examples 1 to 3, respectively, and FIG. 23 shows a photograph showing the pore state of the sample piece according to Comparative Example 6.

Regarding the sample pieces of Examples 13 to 18 and Comparative Example 6, air permeation amount, water permeation amount and hardness were measured. The air permeation amount was measured as follows. A sample piece was wound with a sealing tape for preventing leakage from the side, and covered with a tube. Pressure of 0.5 kgf/cm² was applied to the sample piece from the one side thereof, and air permeated was collected in a measuring cylinder with a water substitution method. Volume of air collected within a unit time was measured. Similarly, the water permeation amount was measured as follows. A sample piece was wound with a sealing tape for preventing leakage from the side, and covered with a tube. Water pressure of 0.5 kgf/cm² was applied to the sample piece from the one side thereof, and water permeated was collected in a measuring cylinder. Volume of water collected within a unit time was measured. The hardness was measured with Durometer A hardness meter according to JIS K6253 (ISO 7619). Measurement results of those air permeation amount, water permeation amount and hardness are shown in Tables 2 and 3.

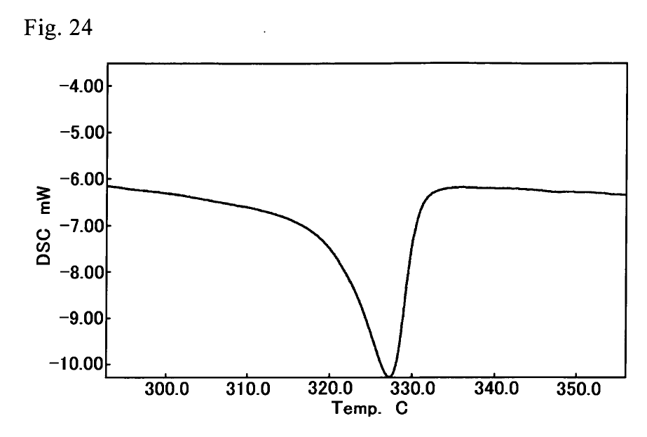

Regarding the sample pieces according to Examples 1 to 19 and the sample pieces according to Comparative Examples 1 to 6, differential scanning calorimetry (DSC) was performed by a transition heat measurement method of JIS K7122 plastic, and an endothermic peak was confirmed in a crystal fusion curve obtained thereby. According to the DSC, a peak was observed in the vicinity of 320 to 330° C., which is characteristic to a completely baked PTFE, in any of the sample pieces. From this fact, it can be confirmed that a completely baked PTFE is formed by the baking treatment at 400° C. for 10 minutes. FIG. 24 shows the crystal fusion curve of Example 1.

TABLE 1

| | | | | | | | | | | | | Ex. | Ex. | Ex. |
|---|---|---|---|---|---|---|---|---|---|---|---|---|---|---|
| | | | Ex. 1 | Ex. 2 | Ex. 3 | Ex. 4 | Ex. 5 | Ex. 6 | Ex. 7 | Ex. 8 | Ex. 9 | 10 | 11 | 12 |
| Constitution | PTFE | | 100 | 100 | 100 | 100 | 100 | 100 | 100 | 100 | 100 | 100 | 100 | 100 |
| (part by | Pore | Naphtha | 42 | 36.6 | 66.6 | 37.3 | 46.3 | 32.3 | — | — | — | 5.7 | 7.6 | 6.6 |
| weight) | forming | Camphor | 58 | 107.3 | 166.5 | — | — | — | 58.8 | 23 | 65.5 | 11 | 38.1 | 22.3 |
| | agent | Menthol | — | — | — | 58.8 | 97.6 | 190 | 101.7 | 157.1 | 179.3 | 60.6 | 132 | 157.6 |

| | | | | | | | | | | | | |
|---|---|---|---|---|---|---|---|---|---|---|---|---|
| Porosity (%) | 29.9 | 49.9 | 65.3 | 24.1 | 45.1 | 59.6 | 46.7 | 60.3 | 63.5 | 34.8 | 56.1 | 63.1 |
| Pore state* | A | A | A | A | A | A | A | A | A | A | A | A |

*A: Fine and uniform

TABLE 2

| | | | Ex. 13 | Ex. 14 | Ex. 15 | Ex. 16 | Ex. 17 | Ex. 18 | Ex. 19 |
|---|---|---|---|---|---|---|---|---|---|
| Constitution | PTFE | | 100 | 100 | 100 | 100 | 100 | 100 | 100 |
| (part by | Pore | Naphtha | 12.5 | 16.3 | 7.7 | 10.6 | 12.5 | 14.3 | 50 |
| weight) | forming | Camphor | 137.5 | 8.8 | 37.5 | 102.1 | 137.5 | 171.4 | 350 |
| | agent | | | | | | | | |

| | | | | | | | |
|---|---|---|---|---|---|---|---|
| Integration of particles | None | Present | Present | Present | Present | Present | Present |
| Porosity (%) | 61.2 | 3.8 | 36.4 | 59.0 | 62.4 | 68.0 | 81.0 |
| Pore state* | B | A | A | A | A | A | A |
| Average pore diameter (μm) | 64 | 94 | 47 | 30 | 39 | 38 | 36 |
| Air permeation amount (ml/min) | 1710 | 0 | 2.7 | 147 | 322 | 440 | — |
| Water permeation amount (ml/min) | 40 | 0 | 0 | 2 | 5.4 | 6 | — |
| Hardness | A67 | A95 | A91 | A73 | A72 | A61 | A49 |

*A: Fine and uniform
B: Slightly fine and uniform

TABLE 3

| | | | Comparative | Comparative | Comparative | Comparative | Comparative | Comparative |
|---|---|---|---|---|---|---|---|---|
| | | | Example 1 | Example 2 | Example 3 | Example 4 | Example 5 | Example 6 |
| Constitution | PTFE | | 100 | 100 | 100 | 100 | 100 | 100 |
| (part by | Pore | Naphtha | 40 | 50 | 66.6 | 20 | 30 | — |
| weight) | forming | Ammonium | 60 | 100 | 166.5 | — | — | — |
| | agent | bicarbonate | | | | | | |

| | | | | | | |
|---|---|---|---|---|---|---|
| Porosity (%) | 46.7 | 60.3 | 63.5 | 0 | 0 | 7.4 |
| Pore state* | Slightly | Coarse | Coarse | — | — | Slightly |
| | coarse | | | | | coarse |
| Average pore diameter (μm) | — | — | — | — | — | 181 |
| Air permeation amount (ml/min) | — | — | — | — | — | 7.8 |
| Water permeation amount (ml/min) | — | — | — | — | — | 0.02 |
| Hardness | — | — | — | — | — | A95 |

In the Examples, any one of Examples 1 to 12 using the pore forming agent containing a viscous body, Example 13 using a specific powder as the pore forming agent, and Examples 14 to 19 using integrated particles of the powdery pore forming agent and the PTFE powder could optionally change the porosity by the blending amount of the pore forming agent. Further, it was confirmed in any one of Examples that the pore state was fine and uniform, and the PTFE porous body I having fine texture was formed regardless of high or low porosity. In the Examples, samples having the porosity of from 3.8 to 81.0% were prepared, but it is of course possible to prepare products having the porosity less than 3.8% or more than 81.0%.

Examples 13 to 19 prepared the samples by extrusion molding, and this resulted in that shear stress was applied to the side portion of a cylindrical shape. Therefore, it was confirmed that a skin layer was formed on the side portion.

Even in Comparative Examples 1 to 3 using a powdery ammonium bicarbonate as the pore forming agent, it was possible to optionally change the porosity by the blending amount of the pore forming agent. However, in Comparative Example 1 wherein the porosity is relatively low as 36.2%, several slightly coarse pores 2 are observed, and the texture is in a slightly coarse state. In Comparative Example 2 wherein the porosity is 51% and Comparative Example 3 wherein the porosity is 69.1%, many coarse pores 2 are observed, and it was not the state to say that the texture is fine.

Regarding Comparative Examples 4 and 5 using only naphtha which is a liquid having low viscosity as the pore forming agent, because Comparative Example 4 was that the mixing amount of the pore forming agent is small, the pores were crushed by the baking treatment, and the porosity was 0%. In Comparative Example 5 wherein the amount of the pore forming agent is larger than Comparative Example 4, naphtha as the pore forming agent oozed out in molding the mixture, and only the pore forming agent in the same degree of the amount as Comparative Example 4 was held between particles of the PTFE powder. As a result, similar to Comparative Example 4, the porosity was 0%.

From the test results of the air permeation amount and the water permeation amount, Example 13 wherein the PTFE powder and the powdery pore forming agent did not form the integrated particles is that the air permeation amount is very large, and the water permeation amount is also large. Contrary to this, Examples 14 to 18 wherein the PTFE powder and the powdery pore forming agent formed the integrated particles show the results that good air permeation amount can be obtained by controlling the porosity, and further, the water permeation amount is very small. This is due to that the pore diameter of Example 13 is slightly larger than the pore diameter of Examples 14 to 18. Further, in Comparative Example 6, the pore diameter is large, but high porosity is not obtained. As a result, the air permeation amount is very small.

As described above, according to Examples 1 to 12, because the pore forming agent contains a viscous body, the PTFE porous body having fine and uniform pores and also having fine texture can be obtained regardless of high or low porosity. Further, the porosity can easily be controlled by setting the mixing amount of the pore forming agent. Because the viscosity of the pore forming agent itself can be changed by the proportion of the blending component, it is possible to further give good moldability.

According to Example 13, the pore forming agent comprises a specific powder (terpenes). Therefore, the PTFE powder having relatively fine and uniform pores and having fine texture can be obtained. Further, it is possible to easily control the porosity by setting the mixing amount of the pore forming agent. Additionally, according to Example 13, slightly large pores are uniformly formed as described above. Therefore, the air permeation amount is very large, and as a result, such is very useful as a filter for gas-solid separation.

According to Examples 14 to 19, the pore forming agent is the integrated particles of the powdery pore forming agent and the PTFE powder. Therefore, the PTFE porous body having fine and uniform pores and having fine texture can be obtained regardless of high or low porosity. Further, it is possible to easily control the porosity by setting the mixing amount of the pore forming agent. Additionally, according to Examples 14 to 18, the air permeation amount is large and the water permeation amount is very small. Therefore, such is very useful as a filter for gas-liquid separation.

According to the present invention, the assembly including the PTFE porous body having fine texture can be obtained, and further it is possible to easily control the porosity of the PTFE porous body. Such a PTFE porous body can suitably be used in many applications such as a wire covering material, a dielectric of a coaxial cable, a filter, a gasket, a heat-insulating material, a separation membrane, an artificial blood vessel, a catheter and an incubator. Further, the assembly comprising the fluorine rubber molding and such a PTFE porous body held thereon can be used in high temperature environment. Therefore, it is possible to suitably use in, for example, a grommet equipped with a filter used in an oxygen sensor.

What is claimed is:

1. An assembly comprising:
a fluorine rubber molding; and
a polytetrafluoroethylene porous body which has pores and is held on the fluorine rubber molding,
wherein the polytetrafluoroethylene porous body is obtained by: molding a polytetrafluoroethylene paste containing 100 parts by weight of a polytetrafluoroethylene powder and 7 parts by weight or more of a pore forming agent, the pore forming agent being held on the polytetrafluoroethylene powder by viscosity of the pore forming agent; and removing the pore forming agent.

2. The assembly as claimed in claim 1, wherein the polytetrafluoroethylene porous body and the fluorine rubber molding are adhered with an adhesive.

3. The assembly as claimed in claim 1, wherein the polytetrafluoroethylene porous body is provided on a position to be held under a state of the fluorine rubber molding being unvulcanized or semi-vulcanized, and the fluorine rubber molding and the provided polytetrafluoroethylene porous body are heated to vulcanize the fluorine rubber molding, so as to integrate the fluorine rubber molding and the polytetrafluoroethylene porous body.

4. The assembly as claimed in claim 1, wherein the polytetrafluoroethylene porous body has one of grooves and projections, the fluorine rubber molding has other of grooves and projections, and the polytetrafluoroethylene porous body is held on the fluorine rubber molding such that the grooves and projections formed respectively are fitted.

5. The assembly as claimed in claim 1, further comprising a ring member provided around the polytetrafluoroethylene porous body.

6. The assembly as claimed in claim 1, wherein the polytetrafluoroethylene porous body is plated with a metal.
